(19) United States
(12) Patent Application Publication
(10) Pub. No.: US 2008/0279665 A1
(43) Pub. Date: Nov. 13, 2008

(54) Method for the placement and transport of heavy equipment onto the cargo area of a cargo-bearing vehicle and apparatus therefor

(76) Inventor: Goorgen Stepanians, Glendale, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/710,318

(22) Filed: Feb. 22, 2007

(51) Int. Cl. B60P 1/00; B65G 67/00

(52) U.S. Cl. 414/542; 414/809

(57) ABSTRACT

A method and apparatus for the placement and transport of heavy equipment into the cargo area of a cargo-bearing vehicle wherein a collapsible cargo cart designed to hold heavy equipment up to 1000 pounds that has a frame portion, a releasable cargo-holding planar base portion, a removable handle, a first set of legs attached to the frame portion, a second set of legs attached frame portion and a means for allowing the frame to slide into the cargo area of a cargo-bearing vehicle. A crane support can optionally be attached the frame to allow a crane to lift heavy equipment situated beneath the frame portion when the base portion is released creating a space therebetween. One or more braking mechanisms can be added to the frame to prevent the cart from moving once put in place in the cargo area of the cargo-bearing vehicle.

### BACKGROUND OF THE INVENTION

1. Field of the Invention

The present invention relates generally to the field of cargo carts and particularly to a collapsible cargo cart that is designed to move heavy equipment weighing between 500 and 1000 pounds and storing said equipment in the beds of work trucks for transport and/or use.

2. Description of the Prior Art

Collapsible carts have been used in the past, primarily for the moving of immobilized persons, generally known as gurneys. However, these prior art devices typically have a maximum weight occupancy of 350 to 400 pounds. Some examples of this type of device are described in U.S. Pat. No. 2,877,047 to Weil, U.S. Pat. No. 2,841,438 to Weil, U.S. Pat. No. 3,493,262 to Ferneau, U.S. Pat. No. 5,015,024 to Bloemer, and published U.S. Patent application 2006/0082176.

Examples of devices that provide the insertion of a carriage into the load space of a vehicle include U.S. Pat. No. 4,170,379, which provides a carriage with collapsible wheels, which uses the actuation of a grip member to retract a locking bolt or pin from the bore of a member.

There exists a need, however, for a durable equipment cart that is collapsible, heavy duty, capable of lifting very heavy loads and is easy to use.

### SUMMARY OF THE INVENTION

The preferred embodiment of the present invention teaches an apparatus for the placement and transport of heavy equipment onto the cargo area of a cargo-bearing vehicle. The apparatus is a cart that has a portion; a base portion situated inside of the frame portion; a first set of retractable legs with a first set of rolling means, this first set of legs being attached to the frame portion; a second set of retractable legs with a second set of rolling means, this second set of legs being attached to the frame portion; a handle attached to the frame portion on the same end as the first set of legs, the handle being removable to allow the first set of legs to retract into a transport position; and a third set of rolling means allowing for the frame to slide onto the cargo area once the second set of legs are in a retracted position.

The embodiment above can be further modified by defining that the base portion is releasable to create a space between the frame portion and the ground whereupon a piece of heavy equipment can be positioned below the cart for lifting the heavy equipment through the space.

The embodiment above can be further modified by defining that a support is attached to the frame that supports a crane that can lift the heavy equipment through the space.

The embodiment above can be further modified by defining that one or more braking mechanisms are attached to the frame portion to prevent the cart from moving once the cart is placed onto the cargo area.

The embodiment above can be further modified by defining that the first set of legs contain braking mechanisms on the first set of rolling means on the first set of legs.

The embodiment above can be further modified by defining that the second set of legs are thicker than the first set of legs.

The second embodiment of the within invention includes a method for the placement and transport of heavy equipment onto the cargo area of a cargo-bearing vehicle, the method comprising the steps of placing the heavy equipment to be transported on a cart for performance thereof. The cart is comprised of a portion; a base portion situated inside of the frame portion; a first set of retractable legs with a first set of rolling means, this first set of legs being attached to the frame portion; a second set of retractable legs with a second set of rolling a means, this second set of legs being attached to the frame portion; a handle attached to the frame portion on the same end as the first set of legs, the handle being removable to allow the first set of legs to retract into a transport position; and a third set of rolling means allowing for the frame to slide onto the cargo area once the second set of legs are in a retracted position. First, the second set of legs are retracted under the frame portion; then the frame portion is pushed and rolled with the handle partially on to the cargo area of the cargo-bearing vehicle; then the handle is removed; then the first set of legs is retracted into the transport position; then the frame portion is rolled entirely onto the cargo area.

The second embodiment above is further modified by defining that the base portion of the cart is releasable to create a space between the frame portion and the ground whereupon a piece of heavy equipment can be positioned below the cart for lifting the heavy equipment through the space wherein the method further comprises the step of releasing the base portion and placing the heavy equipment into the space created thereunder.

The second embodiment above is further modified by defining that a support is attached to the frame that supports a crane that can lift the heavy equipment through the space, wherein the method further comprises the step of lifting the heavy equipment with the crane through the space.

The second embodiment above is further modified by defining that one or more braking mechanisms are attached to the frame portion to prevent the cart from moving once the cart is placed onto the cargo area, wherein the method further comprises the step of activating the braking mechanisms once the heavy equipment is entirely rolled onto the cargo area of the cargo-bearing vehicle.

### BRIEF DESCRIPTION OF THE DRAWINGS

FIG. 1 is a front perspective view of the invention.

FIG. 2 is a rear perspective view of the invention.

FIG. 3 is a side view of the invention prior to entry onto the cargo area of a cargo-bearing vehicle.

FIG. 4 is taken along the line defined as 4-4 in FIG. 3.

FIG. 5 is taken along the line defined as 5-5 in FIG. 4.

FIG. 6 is a side view of the invention as it enters the cargo area of a cargo-bearing vehicle, second in sequence following FIG. 3.

FIG. 7 is taken along the line defined as 7-7 in FIG. 6.

FIG. 8 is taken along the line defined as 8-8 in FIG. 7.

FIG. 9 is a side view of the invention demonstrating how the first set of legs fold onto the cart, third in sequence following FIG. 6.

FIG. 10 is a side view of the invention as it lies completely in the cargo area of a cargo-bearing vehicle and with the braking mechanism engage, fourth in sequence following FIG. 9.

FIG. 11 is a top view of the invention with the base portion in the closed position.

FIG. 12 is a top view of the invention with the base portion in the released position, allowing for the lifting of equipment therethrough from the ground.

FIG. 13 is a rear perspective view of the invention with a crane attached lifting cargo from the ground to be held by the cart.

FIG. 14 is an alternate embodiment of the invention, illustrating a front perspective view similar to FIG. 1 of the invention with a braking bar in place in its upright position.

FIG. 15 is a side view of the invention in its alternate embodiment with a braking bar in place as it prepares to be loaded onto the cargo area of a cargo-bearing vehicle.

FIG. 16 is taken along the line defined as 16-16 in FIG. 15.

FIG. 17 is a side view of the invention, similar to FIG. 10 with the braking bar folded, but in its retracted position.

FIG. 18 is taken along the long the line defined as 18-18 in FIG. 17.

### DESCRIPTION OF THE REFERENCED NUMERALS

Turning now descriptively to the drawings, in which similar reference characters denote similar elements throughout the several views, the Figures illustrate the cargo cart of the present invention. With regard to the reference numerals used, the following numbering is used throughout the various drawing figures.
10 cart
11 heavy equipment
12 cargo-area
13 cargo-bearing vehicle
14 frame portion
15 first side of frame
16 second side of frame
17 third side of frame
18 fourth side of frame
19 base portion
20 20a, 20b first set of retractable legs
21 21a, 21b first set of rolling means
22 first bracing bar
23 23a, 23b, second set of retractable legs
24 24a, 24b second set of rolling means
25 second bracing bar
26 handle
27 27a, 27b third set of rolling means
28 space between frame and ground
29 29a, 29b crane support
30 crane
31 31a, 31b braking bar mechanisms
32 32a, 32b braking mechanisms on first set of rolling means
33 Gripping part of handle
23 34a, 34b side parts of handle
25 35a, 35b first set of holes in first set of legs
36 36a, 36b first set of pins in first holes in first set of legs
37 37a, 37b second set of holes in second set of legs
38 38a, 38b second set of pins second set of holes in second set of legs
39 39a, 39b first and second hinges on first set of legs
40 40a, 40b chains on first set of legs
41 41a, 41b pins on chains on first set of legs
42 Handle release
43 Base release
44 Base handle
45 45a, 45b chains on second set of legs
46 46a, 46b pins on chains on second set of legs
47 locking bar on one of the second set of legs
48 Cable handle between second set of legs
49 49a, 49b, 49c hinges under base portion
50 mating means
51 Connecting bar
52 52a, 52b opposite ends of handle side bars corresponding to 34a, 34b
53 Removable pin on handle
54 Cable handle between first set of legs
55 55a, 55b pins holding chain between second set of legs
70 70a, 70b chains holding braking mechanism retracted
71 71a, 71b pins holding chains holding braking mechanism retracted
72 72a, 72b pins and chains holding braking mechanism activated
80 Base receptacle unit
81 Sliding assembly

### DETAILED DESCRIPTION OF A PREFERRED EMBODIMENT

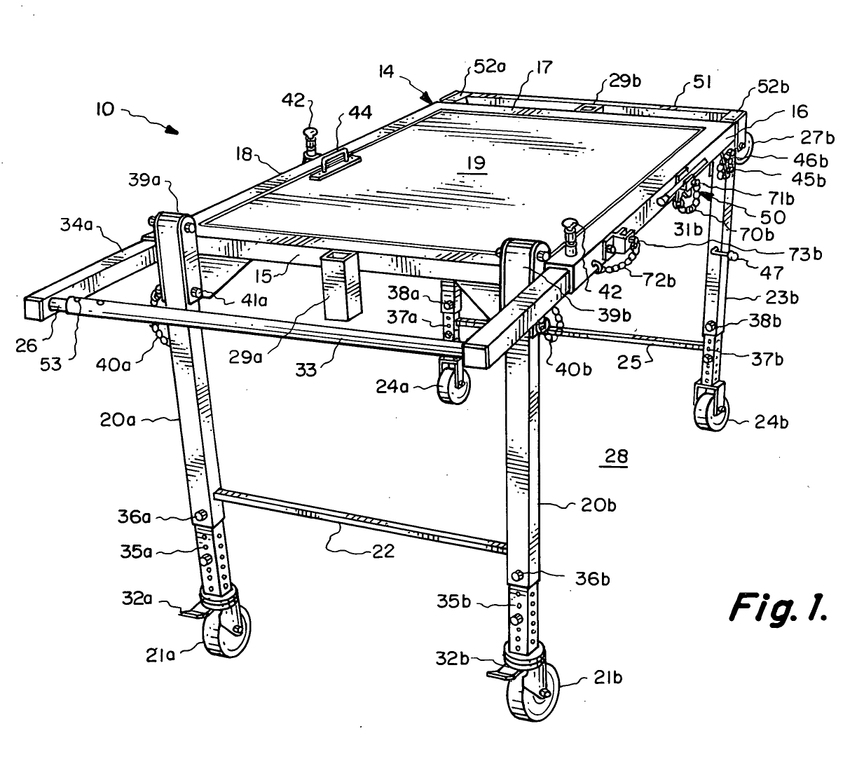

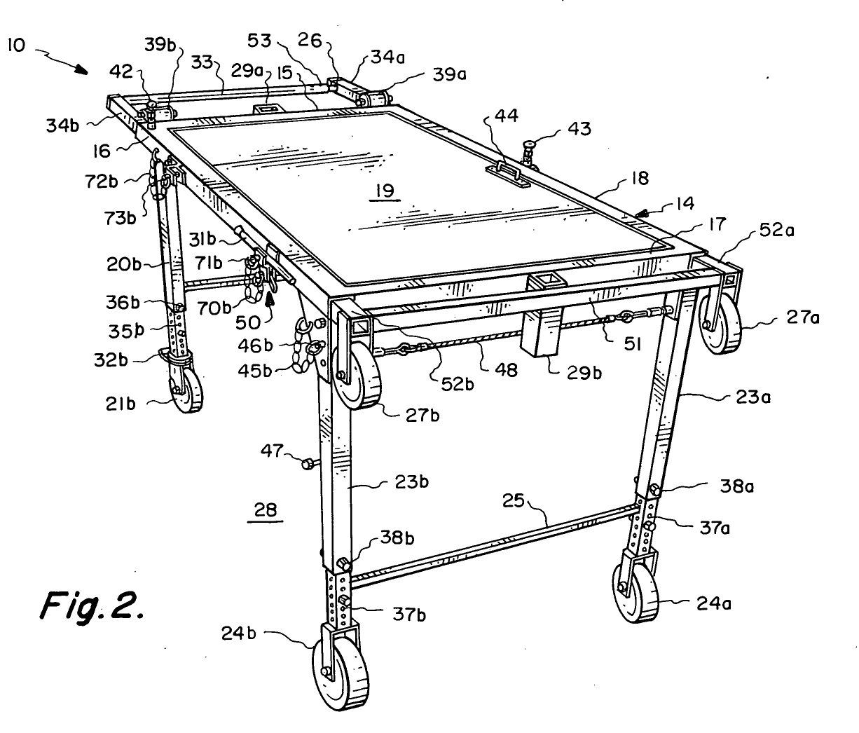

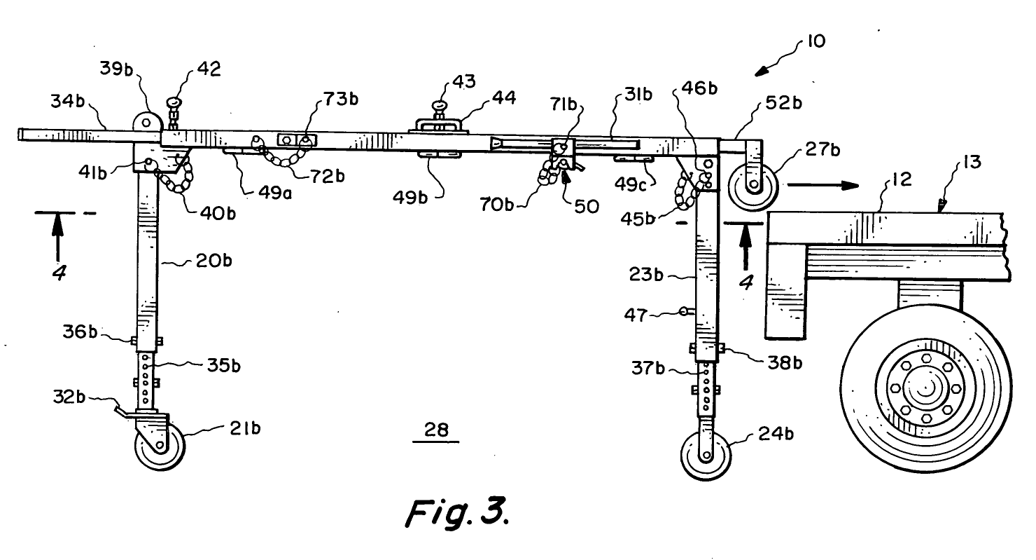

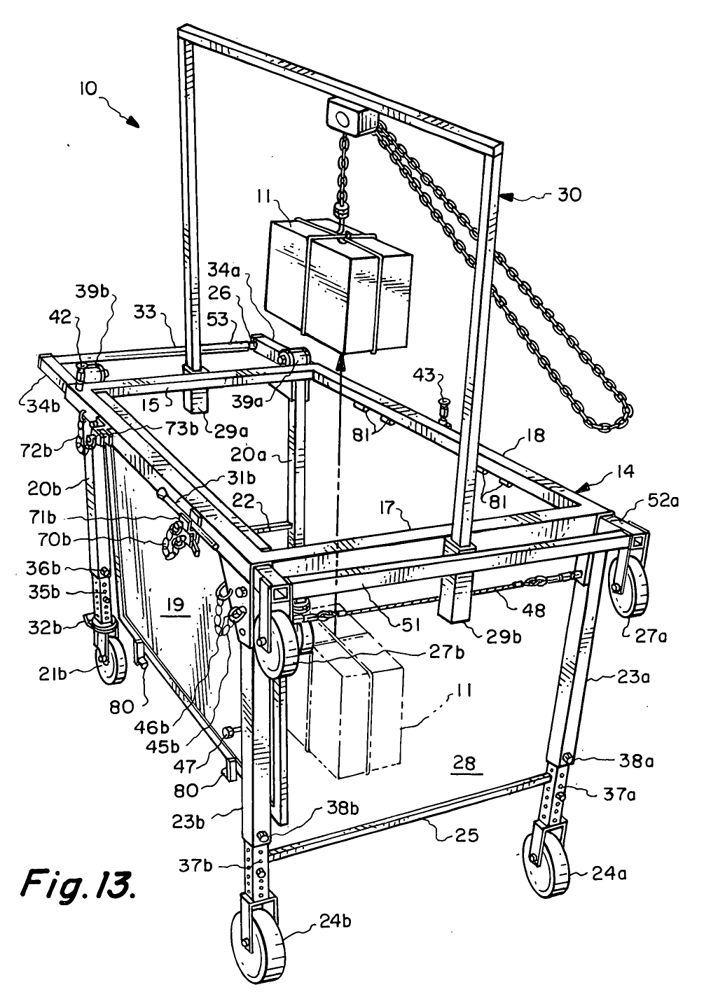

Referring now to the drawings. The preferred embodiment describes a cart 10 that is used for the transport and placement of heavy equipment 11 (see FIG. 13) in the cargo area 12 of a cargo-bearing vehicle 13 (see FIG. 3). The cart 10 is described herein as well as method for its use. FIG. 1 shows a front perspective view of the cart 10 while FIG. 2 shows a rear perspective view. The cart 10 consists of a substantially rectangular frame portion 14 with a first side 15, a second side 16, and third side 17 and a fourth side 18.

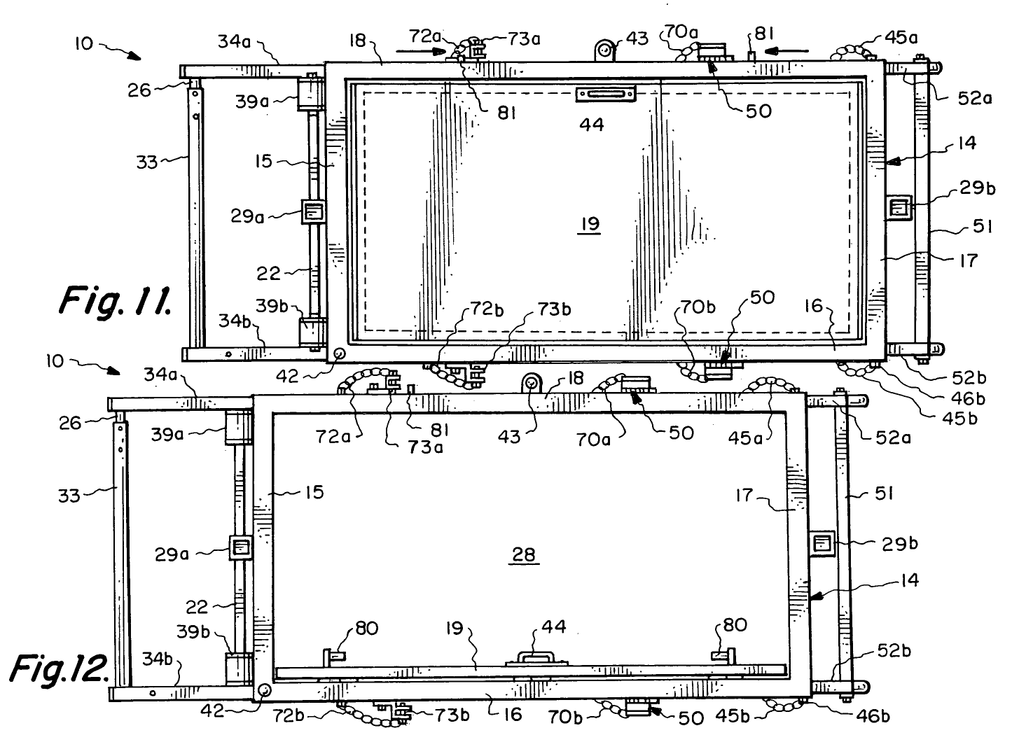

Placed inside of the frame portion 14 is a planar base portion 19 made of wood, steel or some other sturdy material that is optionally releasable as seen in FIGS. 11-13 to expose an open space 28 between the frame portion 14 and the ground for placement of heavy equipment 11. An optional crane 30 is connectible to the frame portion 14 on to supports 29a, 29b on opposing sides of the frame portion 14. A base release 43 is liftable allowing the base portion 19 and to turn on hinges 49a, 49b, 49c located on the underside of the base portion 19. A base handle 44 allows for easy lifting of the base portion 19 back into place once the heavy equipment 11 has been lifted by the crane 30 (See FIG. 13). FIG. 12 shows base 19 is to be released from both receptacle unit 80 and base release 43. The receptacle unit 80 receives sliding assembly 81 before base 19 is released. (See FIGS. 4 and 12).

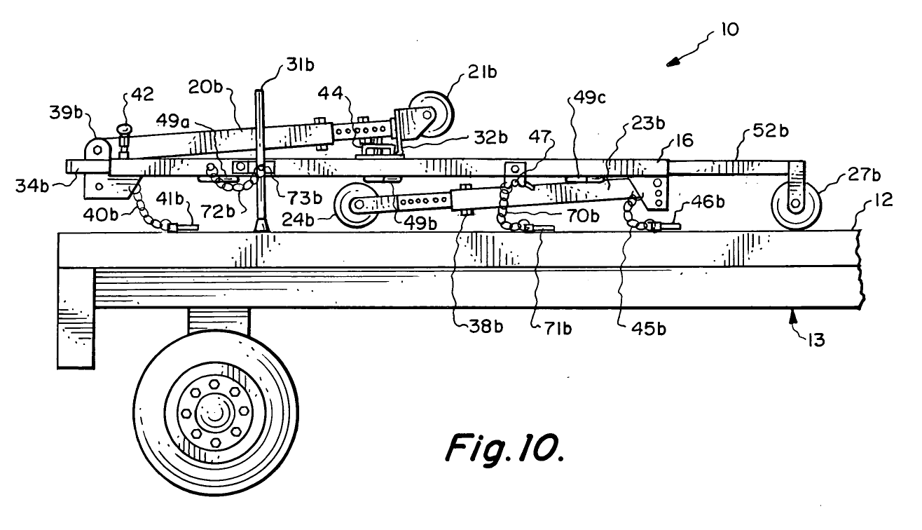

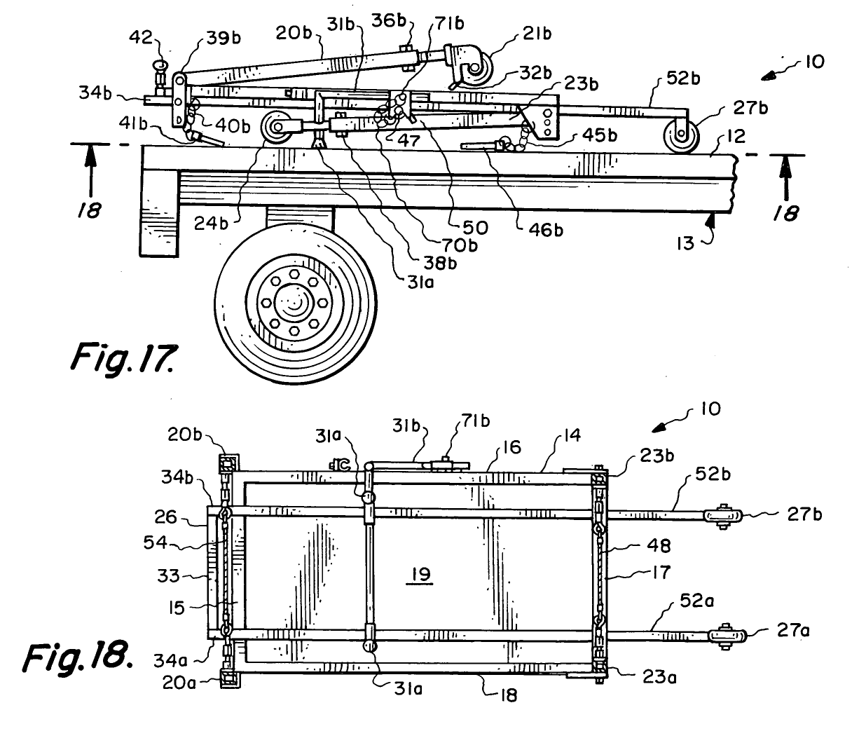

On the front side of the cart 10 and attached to the first side 15 of the frame 14 is a first set of retractable legs 20a, 20b. The first set of retractable legs 20a, 20b can be connected by a first bracing bar 22. A set of hinges 39a, 39b allow the first set of retractable legs 20a, 20b to fold into retracted position. The retracted position can be seen in FIGS. 10 and 17.

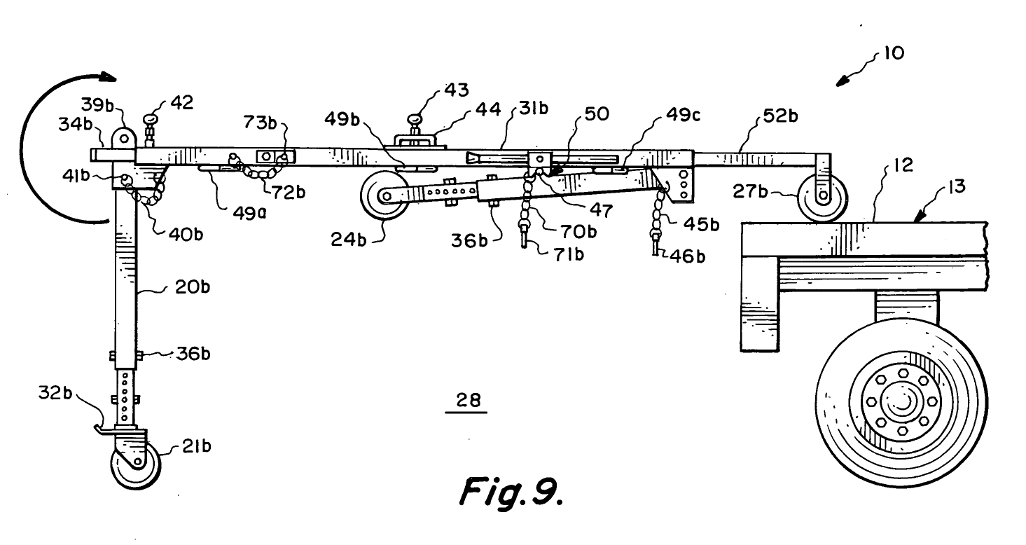

A handle 26, having a gripping portion 33 and two side portions 34a, 34b, is attached to the first side 15 of the frame portion 14. A handle release 42 is located on one side 16 of the frame portion 14 allowing the handle 26 to push the side portions 34a, 34b of the handle 26 through the second 16 and fourth 18 sides of the frame portion 14. The handle 26 is detachable through a pin 53 thereby allowing for the ability to fold the first set of legs 20a, 20b into its retracted position as shown in FIGS. 10 and 17. FIG. 9 shows the handle 26 after removal.

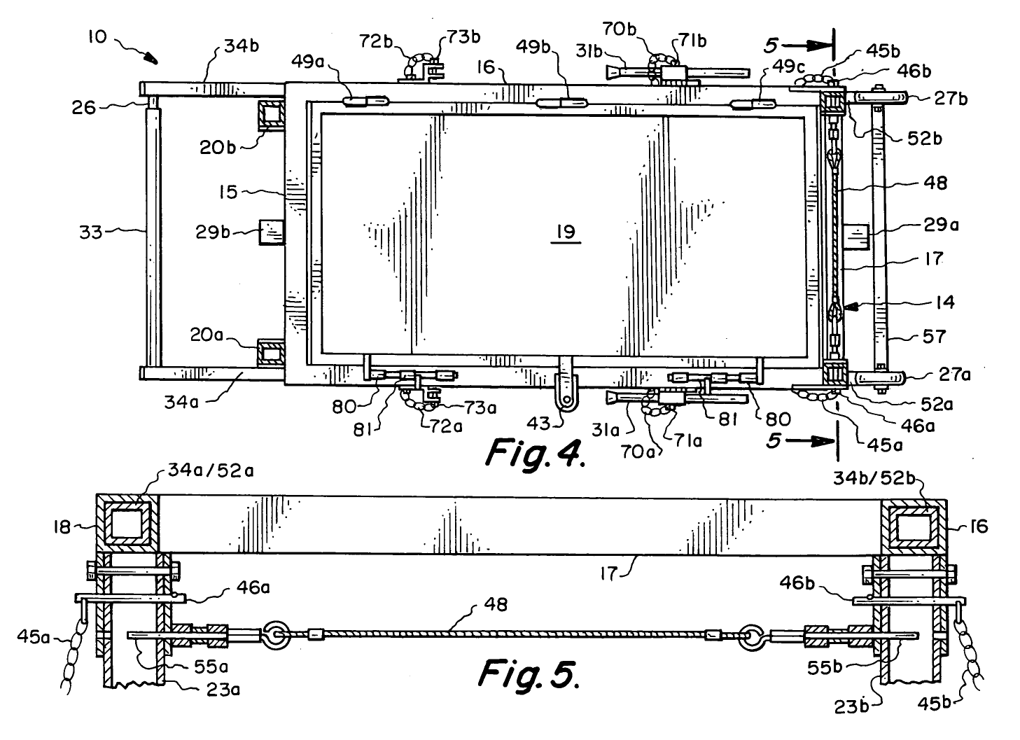

A cable handle 48 is located between the second set of legs 23a, 23b located on the third side 17 of the frame 14 and is releasable as see in FIG. 8. FIG. 5 shows the configuration of the cable handle 48 prior to pressure being put forward on the cable handle 48. The pins 46a, 46b on the second set of legs 23a, 23b are removed releasing the chains 45a, 45b so that the second set of legs 23a, 23b are free to rise. (See FIG. 5.)

The second set of legs 23a, 23b are connected by a second bracing bar 25 analogous to the first bracing bar 22 on the first set of legs 20a, 20b. Both sets of legs 20a, 20b, 23a, 23b are height adjustable through a series of holes 35a, 35b, 37a, 37b and pins 36a, 36b, 38a, 38b that secure the legs 20a, 20b, 23a, 23b to the appropriate height depending upon the height of the cargo area 12 of the cargo-bearing vehicle 13 as well as the size of the heavy equipment 11 to be lifted through the empty space 28 by the crane 30.

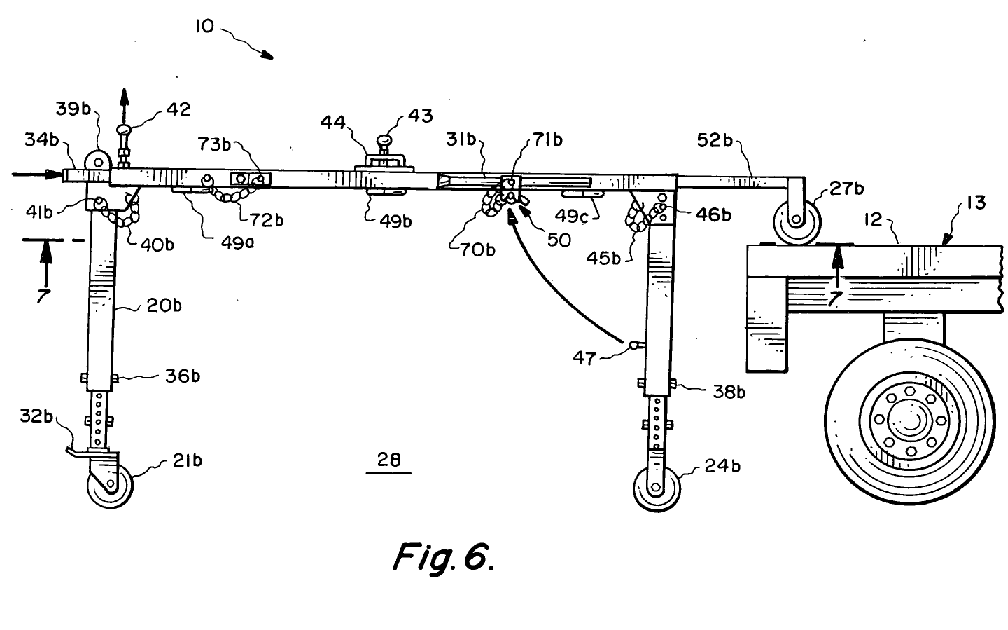

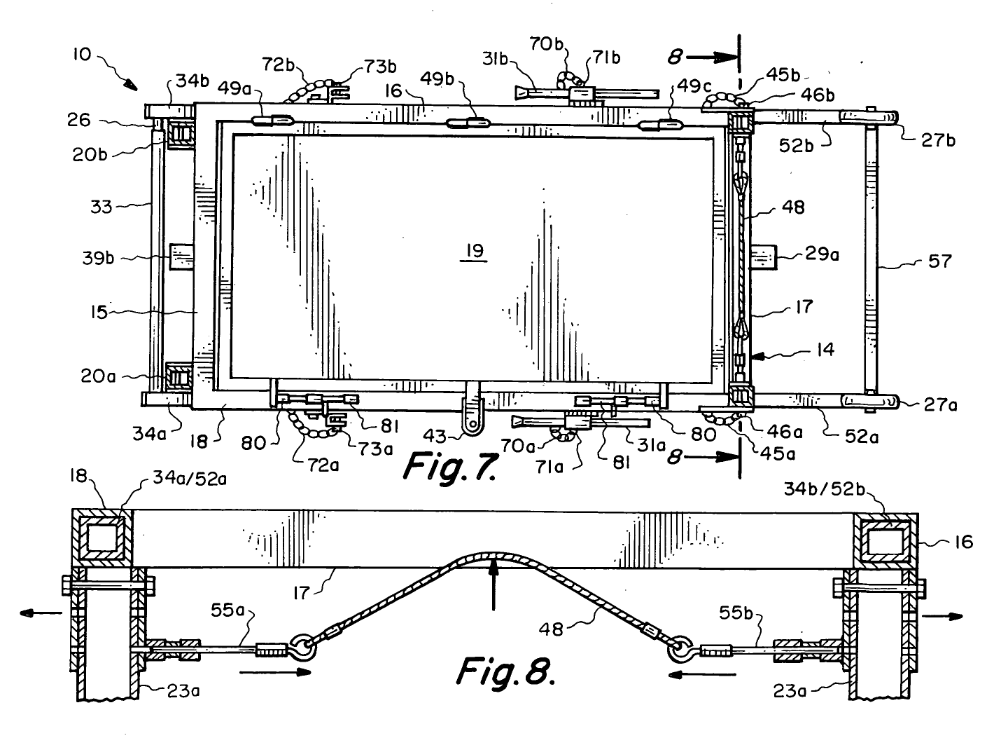

Both sets of legs 20a, 20b, 23a, 23b have rolling means 21a, 21b, 24a, 24b allowing for the rolling of the cart 10 on to the cargo area 12 of a cargo-bearing vehicle 13. For safety the first set of rolling means 21a, 21b on the first set of legs 20a, 20b has braking mechanisms 32a, 32b attached thereto. Additionally, on one of the second set of legs 23b there is a locking bar 47 that secures the leg 23b through the locking bar 47 to the underside of the base portion 19 with a mating means 50. The mating means 50 is shown in FIG. 6 as receiving the locking bar 47 when the leg 23b is in the retracted position (as shown in FIGS. 9, 10 and 17).

Chains 40a, 40b, 45a, 45b also hold pins 41a, 41b, 46a, 46b in place that secure the first set of legs 20a, 20b and the second set of legs 23a, 23b in place when the cart 10 is not in the retracted position.

Located on the third side 17 of the frame portion 14 are the opposite ends 52a, 52b of the handle side portions 34a, 34b and a connecting bar 51 connecting the side portions 52a, 52b together. Connected to each side portion 52a, 52b are a third set of rolling means 27a, 27b. The third set of rolling means 27a, 27b allow for easy movement of the frame portion 14 onto the cargo area 12 of a cargo-bearing vehicle 13.

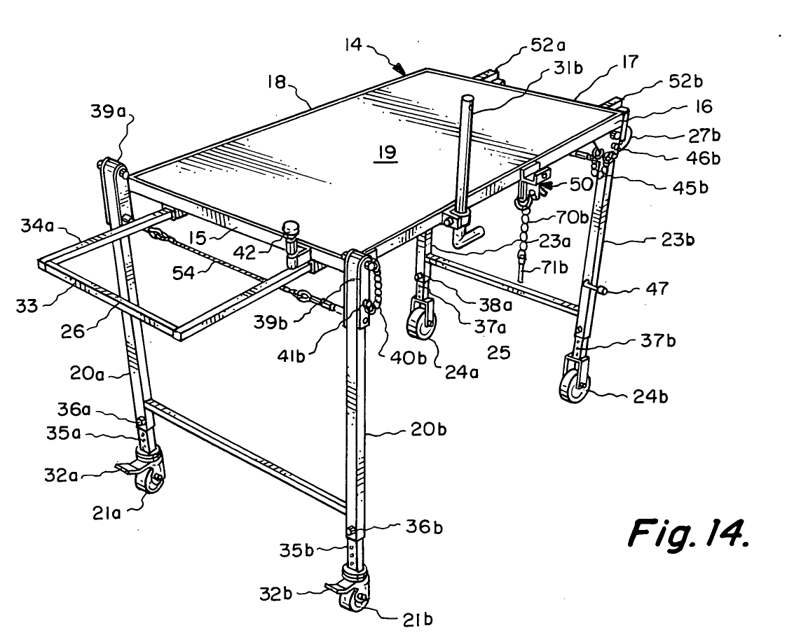

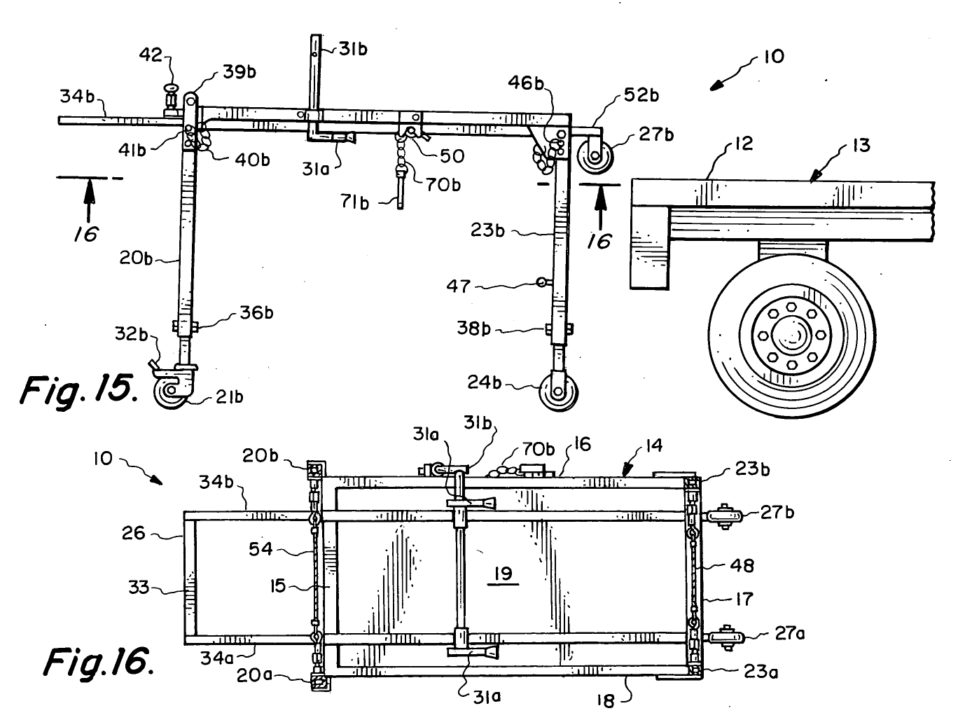

Located on either side of the cart 10 are one or more braking bars 31a, 31b. In the preferred embodiment, the braking bars 31a, 31b are held in place in a position flush with the frame portion 14 until the cart 10 is placed in the cargo area 12 of the cargo-bearing vehicle 13. In an alternative embodiment (FIGS. 14-18), the braking bar 31b is perpendicular to the frame portion 14 until folded by the first set of legs 20a, 20b being placed in the retracted position. In the preferred embodiment, once the cart 10 is in place, the braking bars 31a, 31b are activated and placed in a position perpendicular to the cargo area 12 as seen in FIGS. 10, 14 and 15.

FIGS. 14-18 show an alternate embodiment of the invention. This alternate embodiment is smaller and holds a lighter load. There is no limitation suggested on the size of the load, but it is generally designed to hold loads weighing between 500 and 1000 pounds. The smaller embodiment is made of lighter, thinner materials. In this embodiment is the handle 26 is not removable and the base portion 19 does not open. Furthermore, the braking bar 31b is held in the upright position throughout use until the first set of legs 20a, 20b are folded into their transport position. As seen in FIG. 14, a cable handle 48, 54 between the first set of legs 20a, 20b and the second set of legs 23a, 23b is depressed to allow the first set of legs 20a, 20b and the second set of legs 23a, 23b to retract into their transport positions. Prior to retracting the first set of legs 20a, 20b and the second set of legs 23a, 23b, the handle release 42 is lifted and the handle 26 moved forward through the frame portion 14. Once moved all the way into the frame portion 14, the cable handles 48, 54 are depressed and the first set of legs 20a, 20b and the second set of legs 23a, 23b manipulated into their retracted position as shown in FIG. 17.

The preferred embodiment of the method of the within invention is defined as follows. The cart 10 is held in its non-retracted position as shown in FIGS. 1, 2 and 11. The base portion 19 is optionally opened through the release of the base release 43 and movement of the hinges 49a, 49b, 49c to reveal the open space 28 between the frame portion 14 and the ground as seen in FIG. 13. A crane 30 is placed in the crane supports 29a, 29b and then lifts the heavy equipment 11 to a position suspended above the frame 14. The base portion 19 is then replaced to its closed position and the heavy equipment 11 place thereon.

The cart 10 is then wheeled through pushing the handle 26 and the engagement of the third set of rolling means 27a, 27b as well as the first and second rolling means 21a, 21b, 24a, 24b to the cargo area 12 of a cargo-bearing vehicle 13 as shown in FIG. 3. The handle 26 is then pushed forward as shown in FIG. 6 forcing the side portions 34a, 34b of the handle 26 through the second 16 and fourth 18 sides of the frame portion 14 coming out the other side 52a, 52b and moving the third set of rolling means 27a, 27b onto the cargo area 12 of the cargo-bearing vehicle 13. As seen in FIG. 8, as the handle 26 pushes forward on the cargo area 12 of the cargo-bearing vehicle 13, the cable handle 48 between the second set of legs 23a, 23b, the second set of legs 23a, 23b are forced into their retracted position (as seen in FIG. 9).

The locking bar 47 on the leg 23b engages the mating means 50 located on the underside of the base portion 19. Once the second set of legs 23a, 23b are retracted and secured in place, the handle 26 is then removed. The pins 41a, 41b attached to the chains 40a, 40b of the first set of legs 20a, 20b are then removed to allow for the retraction of the first set of legs 20a, 20b as seen in FIG. 9. The first set of legs 20a, 20b rotate through the hinges 39a, 39b into a retracted position as shown in FIG. 10. The entire cart 10 is then placed on the cargo area 12 of the cargo-bearing vehicle 13. Chains 70a, 70b hold pins 71a, 71b in place when not in use. Then chains 70a, 70b are removed after removal of the pins 71a, 71b so that the braking mechanism 31a, 31b can be held by pins and chains 72a, 72b in the braking position, as seen in FIGS. 9 and 10.

Once on the cargo area 12 of the cargo-bearing vehicle 13, the cart 10 is held in place by one or more braking mechanisms 31a, 31b located flush to the second 16 and fourth 18 sides of the frame portion 14 when not engaged. The braking bars 31a, 31b are placed in a position perpendicular to the cargo area 12 as shown in FIG. 10 to secure the cart 10 in the cargo area 12 of the cargo-bearing vehicle 13. Once situated this way, it is safe to transport the heavy equipment 11 in the cargo-bearing vehicle 13.

Optionally, the second set of legs 23a, 23b can optionally be significantly thicker in dimension that the first set of legs 20a, 20b for added strength.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A cart for the placement and transport of heavy equipment onto the cargo area of a cargo-bearing vehicle, said cart comprising a frame portion;
a base portion situated inside of said frame portion;
a first set of retractable legs with a first set of rolling means, said first set of legs being attached to said frame portion;
a second set of retractable legs with a second set of rolling a means, said second set of legs being attached to said frame portion;
a handle attached to said frame portion on the same side of said frame portion as said first set of legs; and
a third set of rolling means allowing for said frame to slide onto said cargo area of said cargo-bearing vehicle once said second set of legs are in a retracted position.

2. A cart as defined in claim 1 wherein said base portion is releasable to create a space between said frame portion and the ground whereupon a piece of heavy equipment can be positioned below said cart for lifting said heavy equipment through said space.

3. A cart as defined in claim 2 wherein a support is attached to said frame that supports a crane that can lift said heavy equipment through said space.

4. A cart as defined in claim 1 wherein one or more braking mechanisms are attached to said frame portion to prevent said cart from moving once said cart is placed onto said cargo area.

5. A cart as defined in claim 1 wherein said first set of legs contains braking mechanisms on said first set of rolling means on said first set of legs.

6. A cart as defined in claim 1 wherein said second set of legs are thicker than said first set of legs.

7. A cart as defined in claim 1 wherein said handle is removable to allow said first set of legs to retract into a transport position.

8. A method for the placement and transport of heavy equipment onto the cargo area of a cargo-bearing vehicle, said method comprising the steps of
placing said heavy equipment to be transported on a cart for performance thereof, said cart comprising
a frame portion;
a base portion situated inside of said frame portion;
a first set of retractable legs with a first set of rolling means, said first set of legs being attached to said frame portion;
a second set of retractable legs with a second set of rolling a means, said second set of legs being attached to said frame portion;
a handle attached to said frame portion on the same side of said frame portion as said first set of legs;
a third set of rolling means allowing for said frame to slide onto said cargo area of said cargo-bearing vehicle once said second set of legs are in a retracted position;
retracting of said second set of legs under said frame portion;
partially rolling of said frame portion on to said cargo area of said cargo-bearing vehicle with said handle;
retracting of said first set of legs;
rolling of said frame portion entirely onto said cargo area of said cargo-bearing vehicle.

9. A method as defined in claim 8 wherein said base portion is releasable to create a space between said frame portion and the ground whereupon a piece of heavy equipment can be positioned below said cart for lifting said heavy equipment through said space wherein said method further comprises the step of releasing said base portion and placing said heavy equipment into said space created thereunder.

10. A method as defined in claim 9 wherein a support is attached to said frame that supports a crane that can lift said heavy equipment through said space, wherein said method further comprises the step of lifting said heavy equipment with said crane through said space.

11. A method as defined in claim 8 wherein one or more braking mechanisms are attached to said frame portion to prevent said cart from moving once said cart is placed onto said cargo area, wherein said method further comprises the step of activating said braking mechanisms once said heavy equipment is entirely rolled onto said cargo area of said cargo-bearing vehicle.

12. A method as defined in claim 8 wherein said handle is removable to allow said first set of legs to retract into a transport position wherein the method further comprises the step of removing said handle prior to folding said first set of legs in the transport position.
